(19) United States
(12) Patent Application Publication
(10) Pub. No.: US 2024/0072431 A1
(43) Pub. Date: Feb. 29, 2024

(54) ANTENNA DOME ASSEMBLY

(71) Applicant: POYNTING ANTENNAS (PTY) LIMITED, Samrand (ZA)

(72) Inventors: Andries Petrus Cronje FOURIE, Parkview (ZA); Shane Michael MUNDY, Centurion (ZA)

(21) Appl. No.: 18/357,893

(22) Filed: Jul. 24, 2023

(30) Foreign Application Priority Data
Aug. 25, 2022 (NL) 2032853

(51) Int. Cl. H01Q 1/42; H01Q 21/20

(52) U.S. Cl. CPC H01Q 1/422; H01Q 21/205

(57) ABSTRACT

A antenna dome assembly 10 comprises a dome 12 having a main vertical axis 14 and comprising a sidewall 16 having an external surface 18 and an internal surface 20 defining a first chamber 22. The first chamber has an axially extending centre region 24 and an axially extending outer band region 26 between the centre region 24 and the internal surface 20. The centre region 24 extends between 20% and 80% of a transverse line 28 through the dome. The assembly 10 further comprises an array 30 of elongate omnidirectional antennas. The array comprises at least one elongate omnidirectional antenna 32 having a vertical polarization and at least one elongate omnidirectional antenna 34 having a horizontal second polarization. The antennas of the array 30 are mounted in spaced relation relative to one another in at least one of: in the band region 26, on the internal surface 20 and on the external surface 22.

This invention relates to an antenna dome assembly and more particularly to an antenna dome assembly for a water going vessel, such as a marine vessel.

It is known that marine vessels are equipped with a plurality of different antennas to enable satellite communications as well wireless communications with terrestrial stations. This often result in a complex array or “antenna farm” of on-deck antennas which may be unnecessarily bulky and aesthetically not pleasing on at least some vessels, such as luxury yachts.

### OBJECT OF THE INVENTION

Accordingly, it is an object of the present invention to provide an antenna dome assembly with which the applicant believes the aforementioned disadvantages may at least be alleviated or which may provide a useful alternative for the known antenna dome assemblies.

### SUMMARY OF THE INVENTION

According to the invention there is provided an antenna dome assembly comprising:
a dome having a main vertical axis and comprising a sidewall having an external surface and an internal surface defining a first chamber, the first chamber having an axially extending centre region and an axially extending outer band region between the centre region and the internal surface, which band region circumscribes the centre region, the centre region extending between 20% and 80% of a transverse line through the dome;
an array of elongate omnidirectional antennas, the array comprising
   at least one omnidirectional antenna having a first polarization; and
   at least one omnidirectional antenna having a second polarization which is orthogonal to the first polarization
the antennas of the array being mounted in spaced relation relative to one another in at least one of: in the band region, on the internal surface and on the external surface.

The sidewall may be substantially cylindrical in configuration and the centre region may extend between 20% and 80% of a diametric line through the dome.

The antenna dome assembly may be connectable to a n×n multiple-input and multiple-output (MIMO) device having n ports and which n ports are connected to a respective antenna of the array.

The MIMO device may be a MIMO router, also known as a MIMO modem, comprising MIMO technology. MIMO technology is found in modern WI-FI routers and enables multiple antennas to send and receive spatial streams (multiple signals) simultaneously and to differentiate the signals sent to or received from different spatial positions. By leveraging technologies such as spatial multiplexing and space diversity, MIMO boosts the system capacity, coverage range, and SNR without consuming extra bandwidth. All wireless products with IEEE 802.11n-2009 support MIMO.

At least some of the antennas of the array may be mounted on and in conformity with one of the internal surface and the external surface.

At least one of the antennas may comprise a dielectric substrate and conductive antenna elements which are printed or etched on the substrate.

Said at least one antenna may be naked in the sense that it does not comprise an own or dedicated dome, housing or casing.

The first polarization is preferably vertical polarization and the second polarization is preferably horizontal polarization.

The first chamber may be defined between a crown and a heat insulating floor which is axially spaced from the crown.

A rotatable satellite antenna may be located in the centre region.

A second chamber for housing electronic equipment may be defined on the other side of the floor as the first chamber.

The second chamber may be defined between the floor and a heat conductive base of a heatsink assembly, the base having an outer surface.

The heat sink assembly may comprise at least first and second heat conductive plates mounted in parallel and spaced relationship with one another and the outer surface.

The at least first and second heat conductive plates may be mounted in parallel and spaced relationship with one another and the outer surface by heat conductive spacers.

More particularly the heatsink assembly may comprise:
a heat conductive base having a surface;
at least a first heat conductive plate and a second heat conductive plate;
a first heat conductive spacer sandwiched between the surface and the first plate, the first spacer holding the first plate parallel to and in spaced relationship relative to the surface to define a first passage for a cooling fluid medium between the surface and the first plate;
a second heat conductive spacer sandwiched between the first plate and the second plate, the second spacer holding the second plate parallel to and in spaced relationship relative to the first plate to define a second passage for the cooling medium between the first plate and the second plate; and
a link for connecting the first and second plates and the first and second spacers in heat exchanging relationship to the base.

The heatsink assembly may comprise at least a third heat conductive plate and a third heat conductive spacer sandwiched between the second plate and the third plate, the third spacer holding the third plate parallel to and in spaced relationship relative to the second plate to define a third passage for the cooling medium between the second plate and the third plate.

The surface may be flat.

The first and second spacers may be disc-shaped and may define a respective centre eye.

The first and second disc-shaped spacers may be mounted with the respective eyes in register.

The link may comprise a bolt having a shank extending through the respective registering eyes and registering holes in the first plate and the second plate.

The at least first and second plates may define a respective central aperture and the plates may be arranged such that the respective apertures are in register, to define a passage through the assembly for the cooling medium which passage extends transversely the first passage.

According to another aspect of the invention there is provided an antenna dome assembly comprising:
a dome having a main vertical axis and comprising a sidewall having an external surface and an internal surface defining a first chamber, the first chamber having an axially extending centre region and an axially extending outer band region between the centre region and the internal surface, which band region circumscribes the centre region;
an array of elongate omnidirectional antennas, the array comprising
   at least one omnidirectional antenna having a first polarization; and
   at least one omnidirectional antenna having a second polarization which is orthogonal to the first polarization the antennas of the array being mounted in spaced relation relative to one another in at least one of: in the band region, on the internal surface and on the external surface; and
one of electronic and electromagnetic equipment located in the centre region.

The one of electronic and electromagnetic equipment located in the centre region may comprise a satellite dish antenna which is rotatable about the vertical axis.

### BRIEF DESCRIPTION OF THE ACCOMPANYING DIAGRAMS

The invention will now further be described, by way of example only, with reference to the accompanying diagrams wherein:

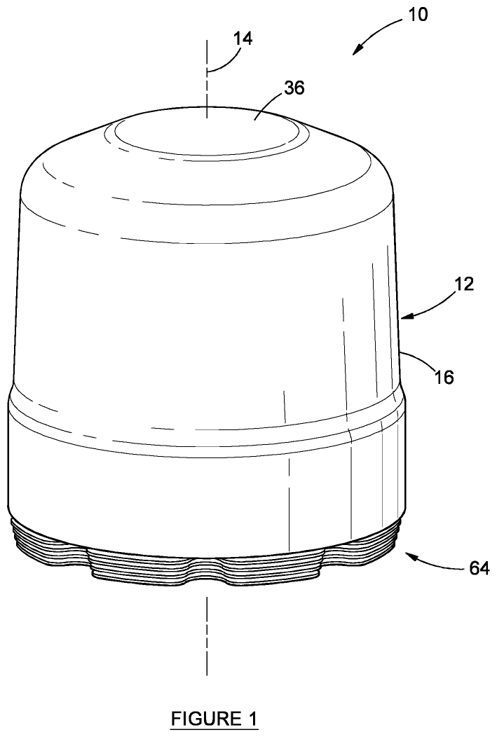

FIG. 1 is a diagrammatic perspective view of a first example embodiment of an antenna dome assembly;

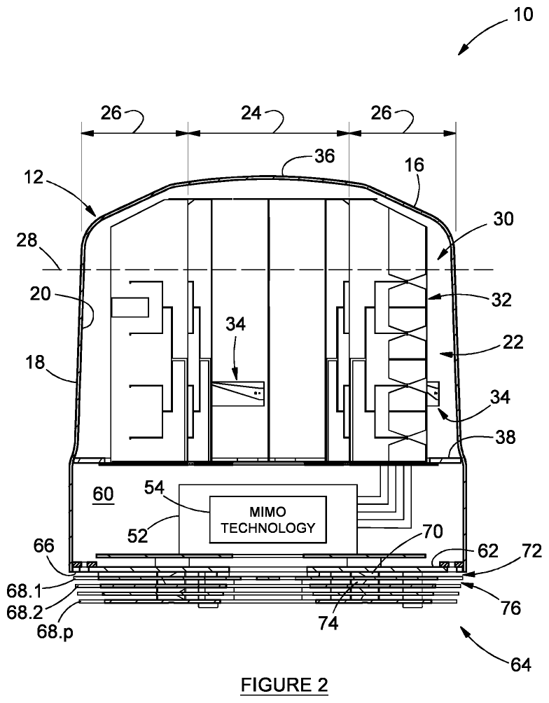

FIG. 2 is an axial section through the assembly of FIG. 1;

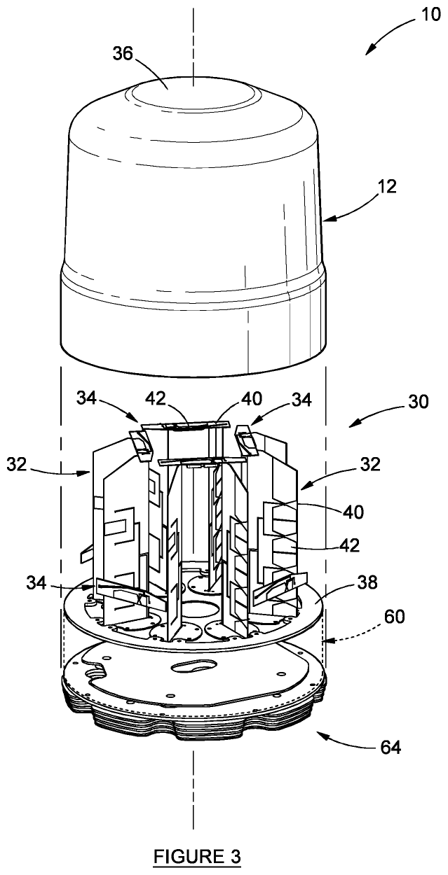

FIG. 3 is diagrammatic perspective view of the assembly partially exploded and wherein certain parts are removed, for better clarity;

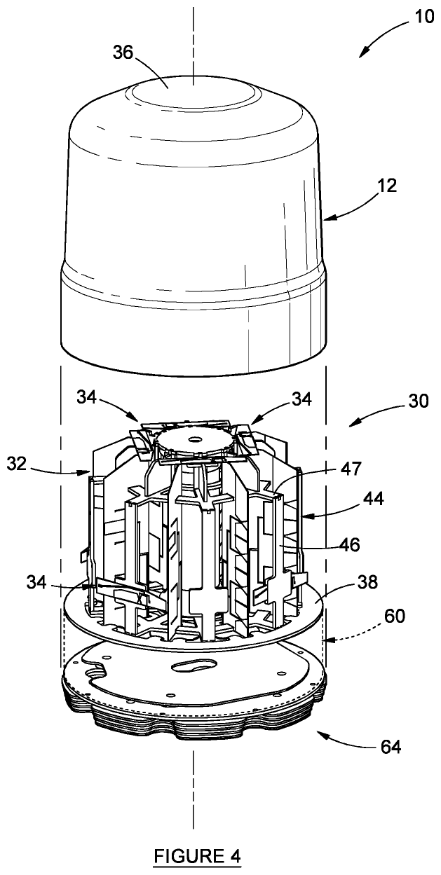

FIG. 4 is a similar view of the assembly, but with the above parts;

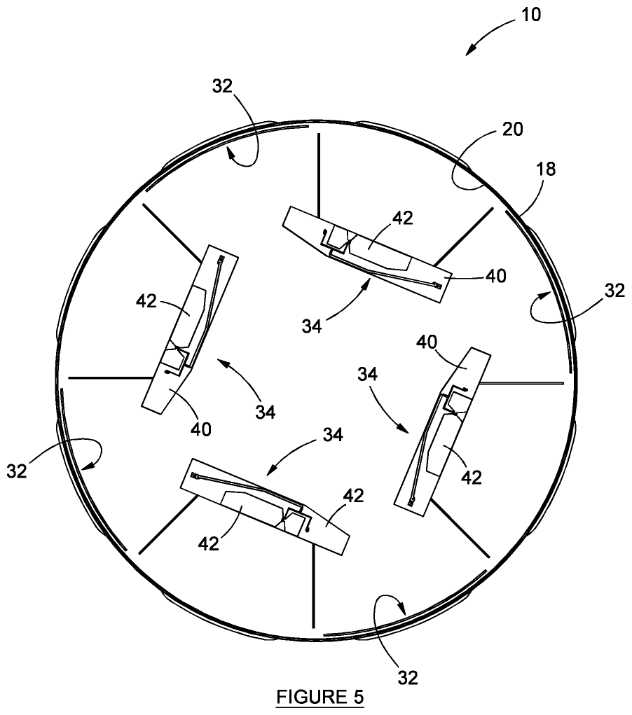

FIG. 5 is a diagrammatic perspective view of a second example embodiment of the assembly;

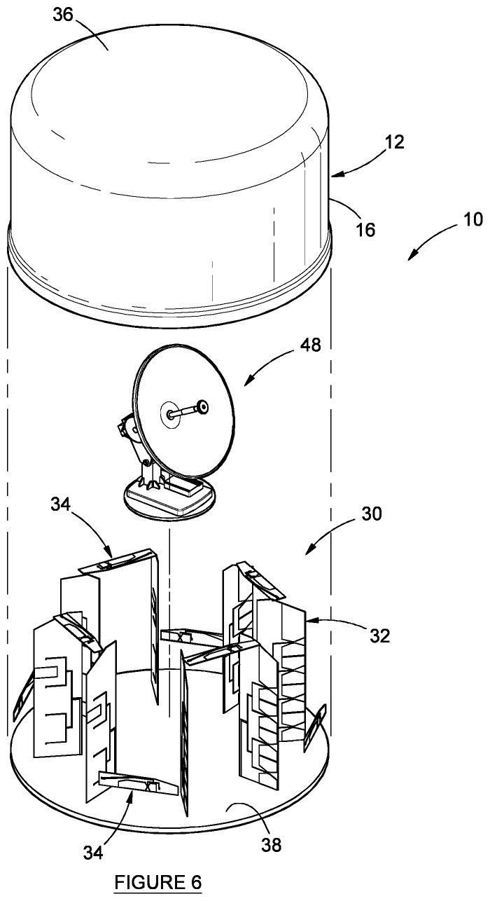

FIG. 6 is a diagrammatic perspective view of a third example embodiment of the antenna dome assembly, comprising a satellite antenna, in partially exploded form;

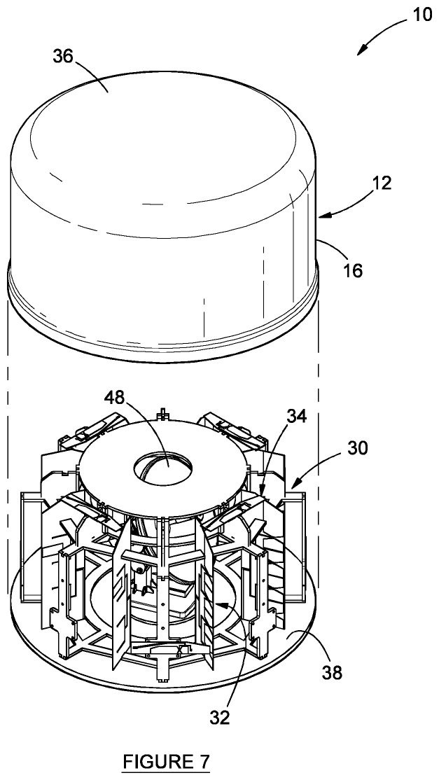

FIG. 7 is a similar view of the third example embodiment with the satellite antenna in position; and

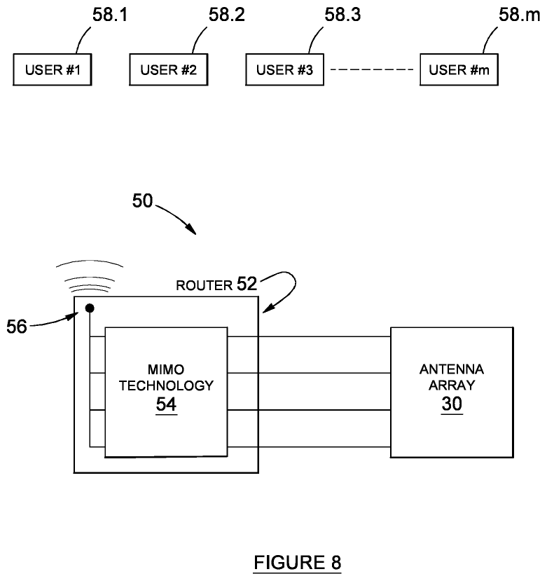

FIG. 8 is a block diagram of a wireless communication system comprising the assembly.

### DESCRIPTION OF A PREFERRED EMBODIMENT OF THE INVENTION

A first example embodiment of an antenna dome assembly is generally designated by the reference numeral 10 in FIGS. 1 to 4.

The antenna dome assembly 10 comprises a dome 12 having a main vertical axis 14 and comprising a sidewall 16 having an external surface 18 (shown in FIG. 2) and an internal surface 20 defining a first chamber 22. The first chamber having an axially extending centre region 24 and an axially extending outer band region 26 between the centre region 24 and the internal surface 20, which band region circumscribes the centre region 22. The centre region 24 extends between 20% and 80% of a transverse line 28 through the dome. The assembly 10 further comprises an array 30 of elongate omnidirectional antennas. The array comprises at least one elongate omnidirectional antenna 32 having a first polarization and at least one elongate omnidirectional antenna 34 having a second polarization, which is orthogonal to the first polarization. The antennas of the array 30 are mounted in spaced relation relative to one another in at least one of: in the band region 26, on the internal surface 20 and on the external surface 22.

The sidewall 16 may be substantially circular cylindrical and the centre region 24 would then extend between 20% and 80% of a diametric line through the dome. The first chamber 22 is defined between the internal surface 20, a crown 36 of the dome and a heat insulating floor 38.

As best shown in FIGS. 3 and 4, each antenna 32, 34 of the array comprises a respective dielectric substrate 40 and conductive elements 42 which are printed or etched on the substrate in known manner.

The antennas 32, 34 are preferably naked in the sense that they do not comprise an own or dedicated dome, housing or casing.

Each antenna may have a bandwidth of from about 617 MHz to about 6000 MHz.

Referring to FIGS. 2 to 4, the omni-directional antennas 32 are mounted vertically, so that these antennas are vertically polarized. The omnidirectional antennas 34 are mounted horizontally, so that these antennas are horizontally polarized.

In this first example embodiment, the substrates 40 are rigid and a framework 44 (shown in FIG. 4) of pillars 46 rising vertically from floor 38 and cross beams 47 supports the substrates of the antennas 32, 34 of the array 30 within in the annular band region 26. In FIG. 3, for the sake of clarity, the framework 44 is not shown, but the array 30 of antennas 32 and 34 is shown located in the annular band region 26.

In a second example embodiment which is shown in FIG. 5, the substrates 40 of the antennas 32, 34 are flexible and the substrates of the vertically mounted antennas 32 are adhered in spaced radial relationship to the internal surface 20 of the sidewall 16 of the dome to conform with a profile of the internal surface. The substrates 40 of the horizontally mounted antennas 34 are adhered to an inner surface of the crown 36 and/or to the internal surface 20 of the sidewall 16 of the dome, in this example embodiment, in a lower region thereof. In other embodiments (not shown) at least some of the substrates may be adhered to the external surface 18 of the sidewall 16 and/or crown 36.

In FIGS. 6 and 7 there is shown a third example embodiment of the assembly 10. In this example embodiment other electronic equipment or electromagnetic equipment is located in the centre region 24 of the first chamber 22. In this case, the equipment comprises a satellite dish 48, which is rotatable about a vertical axis 14 and swiveleable about an axis transverse to the vertical axis. Although, in these figures, the antenna array 30 is shown located in the annular band region 26, it will be appreciated that at least some of the antennas of the antenna array 30 may be adhered to the internal or external surface of the dome, as in the second example embodiment.

It will also be appreciated that in possible embodiments, the antennas of the antenna array 30 may be located in any one of: a) in the band 26, b) on the internal surface 20, c) on the external surface 18 and d) any combination of in the band 26, on the internal surface 20 and on the external surface 18.

In FIG. 8 there is shown a wireless communications system 50 comprising an n×n multiple-input and multiple-output (MIMO) device 52 with MIMO technology 54 which is connected to the antennas of the array 30. In a preferred embodiment, the MIMO device is a 4×4 MIMO cellular router with WiFi functionality 56 to enable user devices 58.1 to 58.m to communicate externally via the system 50. Examples of such routers are those being sold under the trade names PEPLINK|PEPWAVE MAX HD4 \MBX Upgradable Quad-Cellular Gigabit LTE Powerhouse and Celerway's Arcus.

As shown in FIG. 2, a second chamber 60 is defined axially on the other side of the floor 38 as the first chamber 22, between the floor 38 and a heat conductive base 62 of a heatsink assembly 64. The MIMO device 52 and/or other electronic equipment may be located in the second chamber 60 in heat exchanging relationship with the base 62. The base 62 has an outer or bottom surface 66.

The configuration of the heatsink assembly 10 is explained in detail in the applicant's co-pending Dutch priority founding application entitled “Heatsink Assembly”, which has the same priority date as this application and the contents of which are incorporated herein by this reference. The heatsink assembly 64 further comprises at least a first heat conductive plate 68.1 and a second heat conductive plate 68.2. A first heat conductive spacer 70 is sandwiched between the base 62 and the first plate 68.1. The first spacer 70 holds the first plate 68.1 parallel to and in spaced relationship relative to the surface 66, to define a first passage 72 for a cooling fluid medium (not shown) between the surface 66 and the first plate 68.1. A second heat conductive spacer 74 is sandwiched between the first plate 68.1 and the second plate 68.2. The second spacer 74 holds the second plate 68.2 parallel to and in spaced relationship relative to the first plate 68.1, to define a second passage 76 for the cooling medium between the first plate 68.1 and the second plate 68.2. A link connects the first plate 68.1, the second plate 68.2, the first spacer 70 and the second spacer 74 in heat exchanging relationship to the base 62.

1. An antenna dome assembly comprising:
a dome having a main vertical axis and comprising a sidewall having an external surface and an internal surface defining a first chamber, the first chamber having an axially extending center region and an axially extending outer band region between the center region and the internal surface, which band region circumscribes the center region, the center region extending between 20% and 80% of a transverse line through the dome; and
an array of elongate omnidirectional antennas, the array comprising
at least one omnidirectional antenna having a first polarization; and
at least one omnidirectional antenna having a second polarization which is orthogonal to the first polarization the antennas of the array being mounted in spaced relation relative to one another in at least one of: in the band region, on the internal surface and on the external surface.

2. The antenna dome assembly of claim 1 wherein the sidewall is substantially cylindrical in configuration and wherein the center region extends between 20% and 80% of a diametric line through the dome.

3. The antenna dome assembly of claim 1 which is connectable to a n×n multiple-input and multiple-output (MIMO) transceiver having n ports and which n ports are connected to a respective antenna of the array.

4. The antenna dome assembly of claim 1 wherein at least some of the antennas of the array are mounted on and in conformity with one of the internal surface and the external surface.

5. The antenna dome assembly of claim 1 wherein at least one of the antennas comprises a dielectric substrate and conductive antenna elements which are printed or etched on the substrate.

6. The dome assembly of claim 5 wherein said at least one antenna is naked.

7. The antenna dome assembly of claim 1 wherein the first polarization is vertical polarization and the second polarization is horizontal polarization.

8. The antenna dome assembly of claim 1 wherein the first chamber is defined between a crown and a heat insulating floor which is axially spaced from the crown.

9. The antenna dome assembly of claim 1 wherein a rotatable satellite antenna is located in the center region.

10. The antenna dome assembly of claim 1 wherein a second chamber for housing electronic equipment is defined on the other side of the floor as the first chamber.

11. The antenna dome assembly of claim 10 wherein the second chamber is defined between the floor and a heat conductive base of a heatsink assembly, the base having an outer surface.

12. The antenna dome assembly of claim 11 wherein the heat sink assembly comprises at least first and second heat conductive plates mounted in parallel and spaced relationship with one another and the outer surface.

13. The antenna dome assembly as claimed in claim 12 wherein the at least first and second heat conductive plates are mounted in parallel and spaced relationship with one another and the outer surface by heat conductive spacers.

14. An antenna dome assembly comprising:
a dome having a main vertical axis and comprising a sidewall having an external surface and an internal surface defining a first chamber, the first chamber having an axially extending center region and an axially extending outer band region between the center region and the internal surface, which band region circumscribes the center region;
an array of elongate omnidirectional antennas, the array comprising
at least one omnidirectional antenna having a first polarization; and
at least one omnidirectional antenna having a second polarization which is orthogonal to the first polarization
the antennas of the array being mounted in spaced relation relative to one another in at least one of: in the band region, on the internal surface and on the external surface; and
one of electronic and electromagnetic equipment located in the center region.

15. The antenna dome assembly of claim 14 wherein the one of electronic and electromagnetic equipment located in the center region comprises a satellite dish antenna which is rotatable about the vertical.
